(19) United States
(12) Patent Application Publication
(10) Pub. No.: US 2010/0174962 A1
(43) Pub. Date: Jul. 8, 2010

(54) SYSTEMS AND METHODS FOR DATA TRANSMISSION

(75) Inventor: Yan-Xiu ZHENG, Shulin City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/616,799

(22) Filed: Nov. 12, 2009

Related U.S. Application Data
(60) Provisional application No. 61/142,250, filed on Jan. 2, 2009.

(51) Int. Cl. H04L 1/14; G06F 11/14

(52) U.S. Cl. 714/750; 714/E11.131

(57) ABSTRACT

A method for a receiver to provide a plurality of feedbacks to a transmitter, the plurality of feedbacks for use by the transmitter to determine data retransmission. The method includes: mapping the plurality of feedbacks to a sequence of symbols; and transmitting the sequence of symbols to the transmitter.

### RELATED APPLICATIONS

This application is based upon and claims the benefit of priority from U.S. Provisional Patent Application No. 61/142,250, filed Jan. 2, 2009, the entire contents of which are incorporated herein by reference.

### TECHNICAL FIELD

This disclosure relates to systems and methods for data transmission in a communication system.

### BACKGROUND

Traditionally, a communication system may use data retransmission schemes, such as a hybrid automatic repeat request (HARQ) scheme, for data transmission. For example, in a communication system including a transmitter and a receiver, based on the HARQ scheme, the transmitter transmits a plurality of data packets to the receiver on a plurality of HARQ channels. The receiver then provides a plurality of HARQ feedbacks to the transmitter for the plurality of HARQ channels, respectively, to indicate whether the data packets are correctly received on the respective HARQ channels. Based on the plurality of HARQ feedbacks, the transmitter can determine if data retransmission is needed.

For example, if the receiver correctly receives a first data packet on a first one of the HARQ channels, the receiver sends a 1-bit acknowledgement (ACK) feedback, to notify the transmitter that the first data packet was correctly received. As a result, the transmitter transmits a next data packet to the receiver on the first one of the HARQ channels. Also for example, if the receiver does not correctly receive the first data packet, the receiver sends a 1-bit negative acknowledgement (NACK) feedback, to notify the transmitter that the first data packet was not correctly received. As a result, the transmitter transmits a retransmission data packet to the receiver on the first one of the HARQ channels. The retransmission data packet may be the same as the first data packet, or contain error correction information for the first data packet. Data retransmission may further be repeated, until the receiver correctly receives information included in the first data packet.

Typically, the receiver provides the plurality of HARQ feedbacks for the plurality of HARQ channels through an uplink control channel. As a number of the HARQ channels increases, significant overhead may be introduced to the uplink control channel. As a result, system performance may be degraded.

### SUMMARY

According to a first aspect of the present disclosure, there is provided a method for a receiver to provide a plurality of feedbacks to a transmitter, the plurality of feedbacks for use by the transmitter to determine data retransmission, the method comprising: mapping the plurality of feedbacks to a sequence of symbols; and transmitting the sequence of symbols to the transmitter.

According to a second aspect of the present disclosure, there is provided a receiver to provide a plurality of feedbacks to a transmitter, the plurality of feedbacks for use by the transmitter to determine data retransmission, the receiver comprising: a processor, the processor being configured to map the plurality of feedbacks to a sequence of symbols; and transmit the sequence of symbols to the transmitter.

According to a third aspect of the present disclosure, there is provided a method for a transmitter to receive a plurality of feedbacks from a receiver, the plurality of feedbacks for use by the transmitter to determine data retransmission, the method comprising: receiving a sequence of symbols from the receiver; and mapping the sequence of symbols to the plurality of feedbacks.

According to a fourth aspect of the present disclosure, there is provided a transmitter to receive a plurality of feedbacks from a receiver, the plurality of feedbacks for use by the transmitter to determine data retransmission, the transmitter comprising: a processor, the processor being configured to receive a sequence of symbols from the receiver; and map the received sequence of symbols to the plurality of feedbacks.

According to a fifth aspect of the present disclosure, there is provided a computer-readable medium including instructions, executable by a processor of a computer, for performing a method for generating a plurality of sequences of symbols to represent different combinations of feedbacks provided by a receiver to a transmitter, the method comprising: determining the different combinations of feedbacks, based on a number of channels for data transmission and a number of types of feedbacks for each of the channels; and generating, based on a predetermined set of sequences of symbols, a plurality of sequences of symbols to represent the determined combinations of feedbacks, respectively.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 illustrates a block diagram of a communication system for performing data transmission based on a HARQ scheme, according to an exemplary embodiment.

FIG. 2 illustrates a method for a receiver to provide feedback information to a transmitter, according to an exemplary embodiment.

FIG. 3 illustrates a method for a receiver to provide feedback information to a transmitter, according to an exemplary embodiment.

FIG. 4 illustrates a method for a receiver to provide feedback information to a transmitter, according to an exemplary embodiment.

FIG. 5A illustrates a flowchart of a method to generate a set of sequences each to represent a different combination of HARQ feedbacks, according to an exemplary embodiment.

FIG. 5B shows an example of a predetermined sequence set, according to an exemplary embodiment.

FIG. 6 illustrates a flowchart of a method to generate a set of sequences each to represent a different combination of HARQ feedbacks, according to an exemplary embodiment.

FIG. 7A illustrates a flowchart of a method to generate a set of sequences each to represent a different combination of HARQ feedbacks, according to an exemplary embodiment.

FIG. 7B shows an example of a predetermined sequence set, according to an exemplary embodiment.

FIG. 7C is a table showing different combinations of HARQ feedbacks, according to an exemplary embodiment.

FIG. 8 illustrates a block diagram of a transmitter, according to an exemplary embodiment.

FIG. 9 illustrates a block diagram of a receiver, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems and methods consistent with aspects related to the invention as recited in the appended claims.

In the exemplary embodiments, there are provided systems and methods for data transmission based on a hybrid automatic repeat request (HARQ) scheme. The systems may operate in accordance with different standards, including, e.g., the IEEE 802.16 family of standards, the 3rd Generation Partnership Project (3GPP) standard, the High-Speed Packet Access (HSPA) standard, the Long Term Evolution (LTE) standard, the International Mobile Telecommunications-2000 (IMT-2000) standard, the IMT-Advance standard, the IMT family of standards, etc.

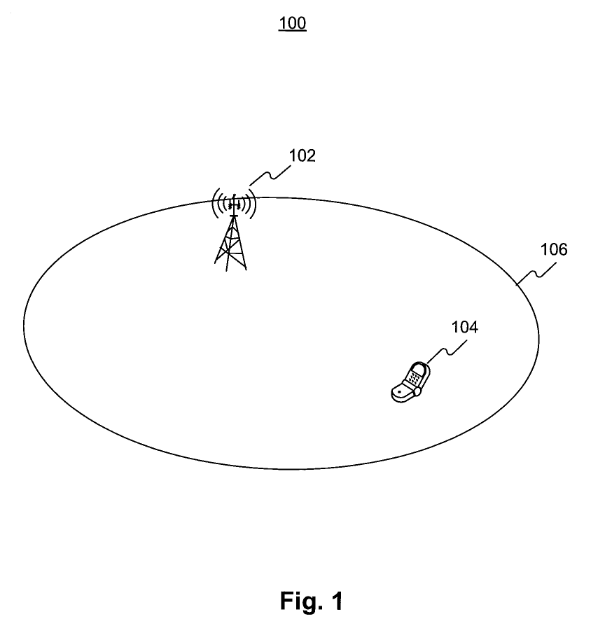

FIG. 1 illustrates a block diagram of a communication system 100 for performing data transmission based on the HARQ scheme, according to an exemplary embodiment. The communication system 100 includes a transmitter 102 and a receiver 104. The receiver 104 is in a coverage area 106 of the transmitter 102. The receiver 104 may communicate with the transmitter 102 based on, e.g., an orthogonal frequency-division multiplexing (OFDM) technique, a code division multiple access (CDMA) technique, a multiple-carrier technique, a time division duplex (TDD) technique, or a multiple-input and multiple-output (MIMO) technique.

In exemplary embodiments, the receiver 104 determines a plurality of HARQ feedbacks to provide for a plurality of HARQ channels, respectively. For example, if a first data packet is correctly received on a first one of the HARQ channels, the receiver 104 determines to provide an acknowledgement (ACK) feedback for the first one of the HARQ channels. Also for example, if a second data packet is not correctly received on a second one of the HARQ channels, the receiver 104 determines to provide a negative acknowledgement (NACK) feedback for the second one of the HARQ channels. Further for example, the receiver 104 determines to provide a drop (DROP) feedback for a third one of the HARQ channels, to request the transmitter 102 to drop a current HARQ transmission process on the third one of the HARQ channels, wherein the DROP feedback indicates that a received data packet is not fully or partially stored by the receiver 104.

In exemplary embodiments, the receiver 104 is configured to map the plurality of HARQ feedbacks to a sequence of symbols, referred to herein as a sequence, such as an orthogonal sequence, a Zadoff-Chu (ZC) sequence, a Walsh sequence, or a generalized-chirp-like (GCL) sequence, and to transmit the sequence to the transmitter 102 to provide feedback information. For example, the receiver 104 includes a memory device (not shown) for storing a first table in which a set of sequences are each mapped to a different combination of HARQ feedbacks. The receiver 104 selects from the first table one of the plurality of sequences corresponding to the plurality of HARQ feedbacks to be provided, and transmits the selected one of the plurality of sequences to the transmitter 102 to provide feedback information.

In exemplary embodiments, because the transmitted sequence includes information regarding multiple HARQ feedbacks, transmission power that would otherwise be expended for each of the HARQ feedbacks may be aggregated for the transmitted sequence, to reduce power consumption and thereby achieve a net power gain. When a signal-to-noise ratio (SNR) is relatively low, the power gain may improve error correction capability of the transmitter 102.

In exemplary embodiments, the transmitter 102 is configured to receive the sequence from the receiver 104, and map the received sequence to the plurality of HARQ feedbacks. For example, the transmitter 102 also includes a memory device (not shown) for storing a second table which is substantially the same as the first table. The transmitter 102 selects, according to the received sequence, a combination of HARQ feedbacks from the second table as the plurality of HARQ feedbacks provided by the receiver 104. The transmitter 102 further determines data retransmission for the HARQ channels based on the plurality of HARQ feedbacks.

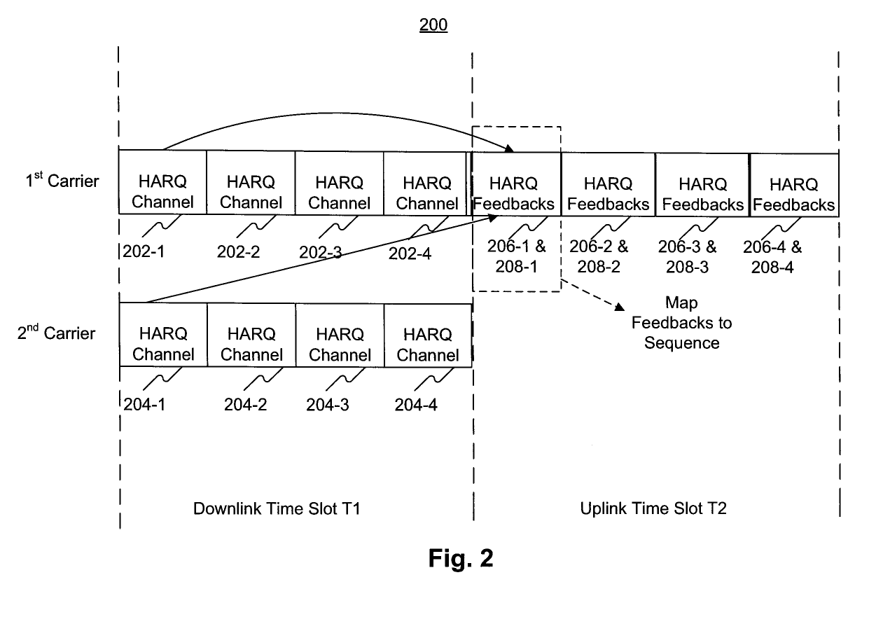

FIG. 2 illustrates a method 200 for the receiver 104 (FIG. 1) to provide feedback information to the transmitter 102 (FIG. 1), according to an exemplary embodiment. In the illustrated embodiment, the transmitter 102 and the receiver 104 are configured to communicate based on multiple carriers, e.g., a first carrier and a second carrier.

Referring to FIGS. 1 and 2, during a downlink time slot T1, the transmitter 102 transmits data to the receiver 104 on a first plurality of HARQ channels 202-1, 202-2, 202-3, and 202-4 on the first carrier, and transmits data to the receiver 104 on a second plurality of HARQ channels 204-1, 204-2, 204-3, and 204-4 on the second carrier. In the illustrated embodiment, the HARQ channels 202-i are concurrently transmitted with the HARQ channels 204-i (i=1, 2, 3, or 4), respectively. For example, the HARQ channels 202-1 and 204-1 are concurrently transmitted.

During an uplink time slot T2, the receiver 104 provides a first plurality of HARQ feedbacks 206-1, 206-2, 206-3, and 206-4 for the HARQ channels 202-1, 202-2, 202-3, and 202-4, respectively, and provides a second plurality of HARQ feedbacks 208-1, 208-2, 208-3, and 208-4 for the HARQ channels 204-1, 204-2, 204-3, and 204-4, respectively. In the illustrated embodiment, the HARQ feedbacks 206-i are concurrently transmitted with the HARQ feedbacks 208-i (i=1, 2, 3, or 4), respectively, on the same carrier. For example, the HARQ feedbacks 206-1 and 208-1 are concurrently transmitted on, e.g., the first carrier. Each of these HARQ feedbacks may be, e.g., an ACK feedback, a NACK feedback, or a DROP feedback.

Accordingly, the receiver 104 maps to a sequence the HARQ feedbacks 206-i and 208-i (i=1, 2, 3, or 4) that are to be concurrently transmitted, and transmits the sequence to the transmitter 102 to provide feedback information, as described above. For example, as shown in FIG. 2, the receiver 104 maps the HARQ feedbacks 206-1 and 208-1 to a first sequence, and transmits the first sequence to the transmitter 102 to provide the feedback information for the HARQ channels 202-1 and 204-1.

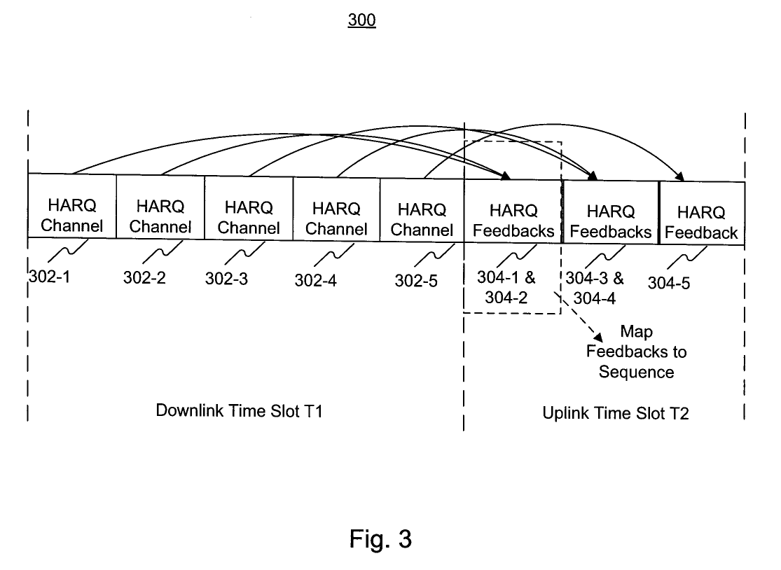

FIG. 3 illustrates a method 300 for the receiver 104 (FIG. 1) to provide feedback information to the transmitter 102 (FIG. 1), according to an exemplary embodiment. In the illustrated embodiment, the transmitter 102 and the receiver 104 are configured to communicate based on the TDD technique. For example, based on the TDD technique, a frequency band may be assigned to both the transmitter 102 and the receiver 104. The transmitter 102 uses the frequency band to provide downlink data transmission to the receiver 104, and the receiver 104 uses the frequency band to provide uplink data transmission to the transmitter 102. Both the uplink data transmission and the downlink data transmission use the same frequency band but at different time slots.

Referring to FIGS. 1 and 3, during a downlink time slot T1, the transmitter 102 transmits data to the receiver 104 on a plurality of HARQ channels 302-1, 302-2, 302-3, 302-4, and 302-5. The HARQ channels 302-1, 302-2, 302-3, 302-4, and 302-5 are sequentially transmitted.

During an uplink time slot T2, the receiver 104 provides a plurality of HARQ feedbacks 304-1, 304-2, 304-3, 304-4, and 304-5 for the HARQ channels 302-1, 302-2, 302-3, 302-4, and 302-5, respectively. For example, the HARQ feedbacks 304-1 and 304-2 are provided for the HARQ channels 302-1 and 302-2, respectively, and are to be concurrently transmitted. Also for example, the HARQ feedbacks 304-3 and 304-4 are provided for the HARQ channels 302-3 and 302-4, respectively, and are to be concurrently transmitted. Further for example, the HARQ feedback 304-5 is provided for the HARQ channel 302-5. Each of these HARQ feedbacks may be, e.g., an ACK feedback, a NACK feedback, or a DROP feedback.

Accordingly, the receiver 104 maps to a sequence the HARQ feedbacks that are to be concurrently transmitted, and transmits the sequence to the transmitter 102 to provide feedback information, as described above. For example, as shown in FIG. 3, the receiver 104 maps the HARQ feedbacks 304-1 and 304-2 to a first sequence, and transmits the first sequence to the transmitter 102 to provide the feedback information for the HARQ channels 302-1 and 302-2.

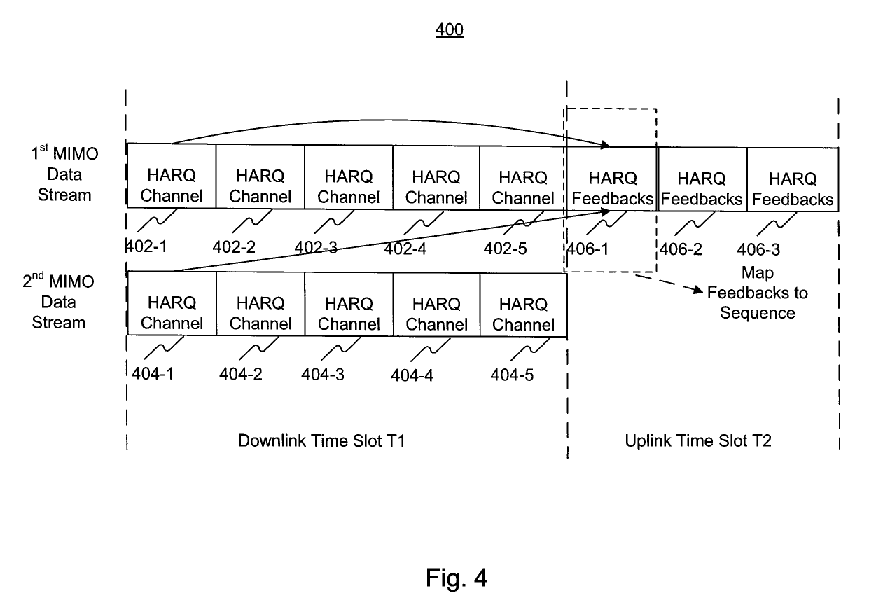

FIG. 4 illustrates a method 400 for the receiver 104 (FIG. 1) to provide feedback information to the transmitter 102 (FIG. 1), according to an exemplary embodiment. In the illustrated embodiment, the transmitter 102 and the receiver 104 are configured to communicate based on the MIMO technique. For example, based on the MIMO technique, each of the transmitter 102 and the receiver 104 may have more than one antenna. As a result, there may be multiple MIMO data streams, e.g., first and second MIMO data streams, transmitted between the transmitter 102 and the receiver 104.

Referring to FIGS. 1 and 4, during a downlink time slot T1, the transmitter 102 transmits the first MIMO data stream to the receiver 104 on a first plurality of HARQ channels 402-1, 402-2, 402-3, 402-4, and 402-5, and transmits the second MIMO data stream to the receiver 104 on a second plurality of HARQ channels 404-1, 404-2, 404-3, 404-4, and 404-5. The HARQ channels 402-i are concurrently transmitted with the HARQ channels 404-i (i=1, 2, 3, 4, or 5), respectively. For example, the HARQ channels 402-1 and 404-1 are concurrently transmitted.

During an uplink time slot T2, the receiver 104 provides a first plurality of HARQ feedbacks 406-1, a second plurality of HARQ feedbacks 406-2, and a third plurality of HARQ feedbacks 406-3 for the HARQ channels 402-1, 402-2, 402-3, 402-4, and 402-5 and the HARQ channels 404-1, 404-2, 404-3, 404-4, and 404-5. For example, the HARQ feedbacks 406-1 are provided for the HARQ channels 402-1 and 404-1, and are to be concurrently transmitted on, e.g., the first MIMO data stream. Each of these HARQ feedbacks may be, e.g., an ACK feedback, a NACK feedback, or a DROP feedback.

Accordingly, the receiver 104 maps to a sequence the HARQ feedbacks that are to be concurrently transmitted, and transmits the sequence to the transmitter 102 to provide feedback information, as described above. For example, as shown in FIG. 4, the receiver 104 maps the uplink HARQ feedbacks 406-1 to a first sequence, and transmits the first sequence to the transmitter 102 to provide the feedback information for the HARQ channels 402-1 and 404-1.

In exemplary embodiments, there is also provided a computer-readable medium including instructions, executable by a processor of a computer, for performing a method for generating a set of sequences to represent different combinations of HARQ feedbacks that may be concurrently transmitted. The generated set of sequences and the different combinations of HARQ feedbacks may then used to create the above-described first and second tables in the receiver 104 and the transmitter 102, respectively.

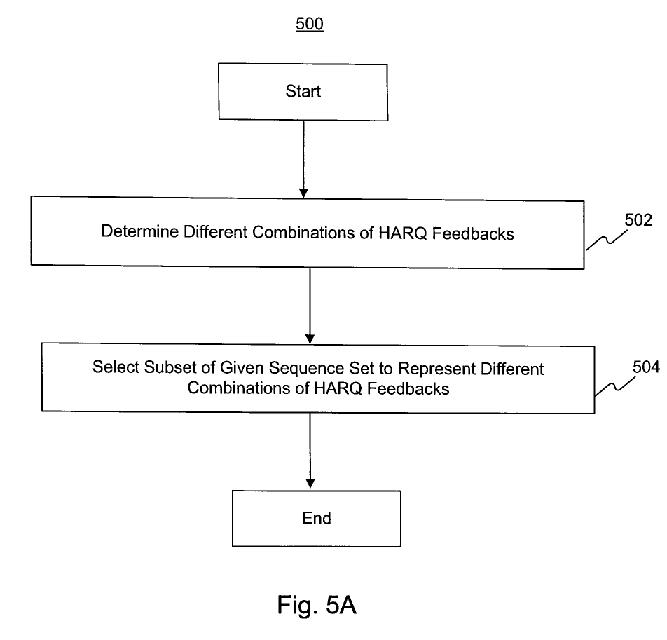

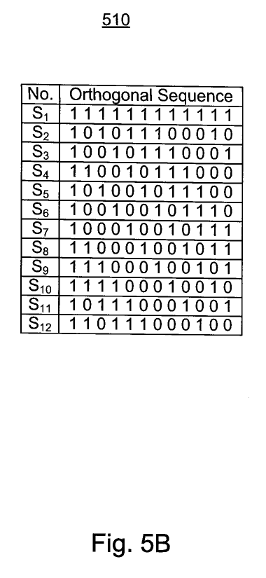

FIG. 5A illustrates a flowchart of a method 500 to generate a set of sequences each to represent a different combination of HARQ feedbacks, according to an exemplary embodiment. For example, the set of sequences is generated from a predetermined sequence set SET0.

In exemplary embodiments, different combinations of HARQ feedbacks to be concurrently transmitted are determined, based on a number of HARQ channels and a number of types of HARQ feedbacks for each of the HARQ channels (502). A subset of the predetermined sequence set SET0 is then selected to represent the different combinations of HARQ feedbacks (504).

FIG. 5B shows an example of the predetermined sequence set SET0, i.e., a predetermined sequence set 510, according to an exemplary embodiment. For example, the predetermined sequence set 510 includes orthogonal sequences S₁, S₂, . . . , and S₁₂, wherein “1” and “0” correspond to modulated symbols +1 and −1, respectively. Also for example, the predetermined sequence set SET0 may also be a ZC sequence, a Walsh sequence, a GCL sequence, etc.

Referring to FIGS. 5A and 5B, in one exemplary embodiment, it is determined that first and second HARQ channels are established between a transmitter and a receiver, and the receiver concurrently transmits to the transmitter first and second HARQ feedbacks for the first and second HARQ channels, respectively. For each of the first and second HARQ channels, the receiver may provide first or second types of HARQ feedbacks, e.g., an ACK feedback or a NACK feedback. Therefore, it is further determined that, for the first and second HARQ channels, there are first, second, third, and fourth combinations of HARQ feedbacks (502).

For example, the first combination may represent that the receiver provides an ACK feedback for the first HARQ channel and also provides an ACK feedback for the second HARQ channel; the second combination may represent that the receiver provides an ACK feedback for the first HARQ channel and provides a NACK feedback for the second HARQ channel; the third combination may represent that the receiver provides a NACK feedback for the first HARQ channel and provides an ACK feedback for the second HARQ channel; and the fourth combination may represent that the receiver provides a NACK feedback for the first HARQ channel and also provides a NACK feedback for the second HARQ channel.

A subset of the predetermined sequence set 510 is then selected to represent the different combinations of HARQ feedbacks (504). For example, a sequence subset including the sequences S₁, S₂, S₃, and S₄ is selected from the predetermined sequence set 510, to represent the first, second, third, and fourth combinations of HARQ feedbacks, respectively. As a result, for example, if the receiver provides an ACK feedback for the first HARQ channel and also provides an ACK feedback for the second HARQ channel, the receiver transmits the sequence S₁ to the transmitter. Also for example, if the receiver provides a NACK feedback for the first HARQ channel and provides an ACK feedback for the second HARQ channel, the receiver transmits the sequence S₃ to the transmitter.

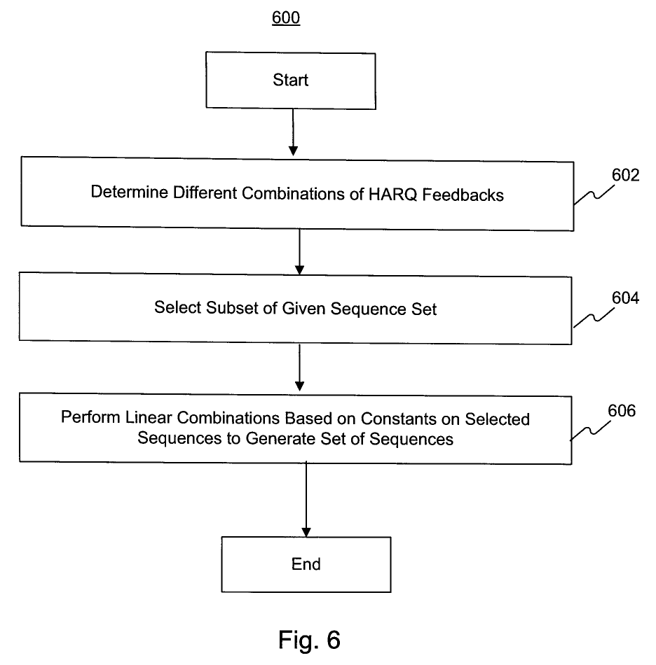

FIG. 6 illustrates a flowchart of a method 600 to generate a set of sequences each to represent a different combination of HARQ feedbacks, according to an exemplary embodiment. For example, the set of sequences is generated based on a predetermined sequence set SET0.

In exemplary embodiments, different combinations of HARQ feedbacks to be concurrently transmitted are determined, based on a number of HARQ channels and a number of types of HARQ feedbacks on each of the HARQ channels (602). A subset of the predetermined sequence set SET0 is then selected from the predetermined sequence set SET0 (604). For example, a subset of N sequences is selected from the predetermined sequence set SET0. Linear combinations based on constants are further performed on the N selected sequences to generate the set of sequences to represent the different combinations of HARQ feedbacks (606).

For example, to perform a linear combination based on constants, the N selected sequences of the subset are first multiplied with a group of constants, respectively, and are then summated to generate a composite sequence, as follows:

Cₖ[p]=Σ_{i≦i≦N}aᵢ[k]Sᵢ[p], equation (1)

where
“Σ” denotes a summation;
i is a sequence index for the N selected sequences;
k is a sequence index for the generated set of sequences;
aᵢ[k] is a group of constants for a k^{th} one of the generated set of sequences;
Sᵢ is an i^{th} one of the N selected sequences;
Sᵢ[p] is a p^{th} symbol of the i^{th} one of the N selected sequences;
Cₖ is the k^{th} one of the generated set of sequences; and
Cₖ[p] is the p^{th} symbol of the k^{th} one of the generated set of sequences.

By multiplying the N selected sequences with different groups of constants, a plurality of composite sequences may be generated, to form the set of sequences to represent the different combinations of HARQ feedbacks.

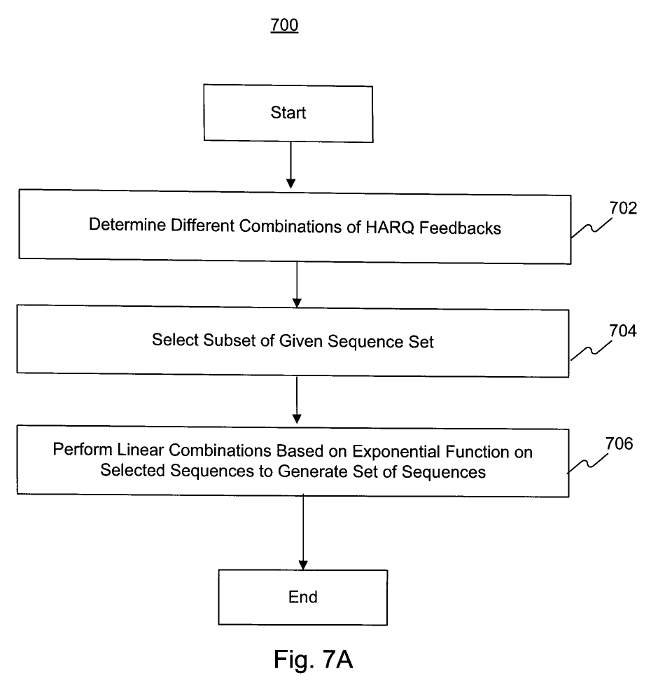

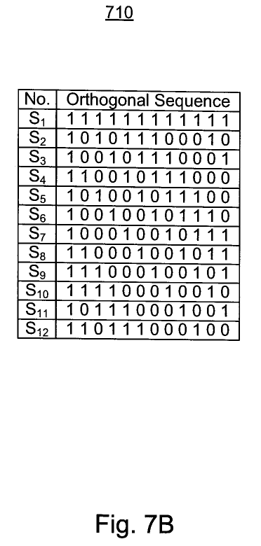

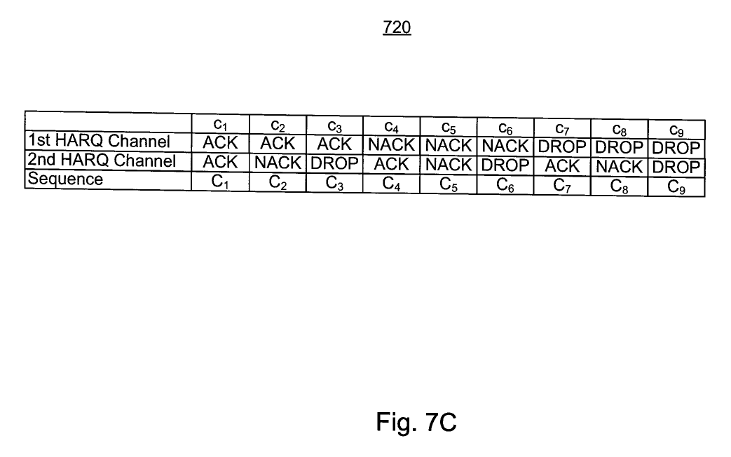

FIG. 7A illustrates a flowchart of a method 700 to generate a set of sequences each to represent a different combination of HARQ feedbacks, according to an exemplary embodiment. For example, the set of sequences is generated based on a predetermined sequence set SET0.

In exemplary embodiments, different combinations of HARQ feedbacks to be concurrently transmitted are determined, based on a number of HARQ channels and a number of types of HARQ feedbacks on each of the HARQ channels (702). A subset of the predetermined sequence set SET0 is then selected from the predetermined sequence set SET0 (704). For example, a subset of N sequences is selected from the predetermined sequence set SET0. Linear combinations based on an exponential function are further performed on the N selected sequences to generate the set of sequences to represent the different combinations of HARQ feedbacks (706).

FIG. 7B shows an example of the predetermined sequence set SET0, i.e., a predetermined sequence set 710, according to an exemplary embodiment. For example, the predetermined sequence set 710 includes orthogonal sequences S₁, S₂, . . . , and S₁₂.

For example, to perform a linear combination based on the exponential function, the N selected sequences are first multiplied with a group of values determined by the exponential function, respectively, and are then summated to generate a composite sequence. By multiplying the N selected sequences with different groups of values determined by the exponential function, a plurality of composite sequences may be generated, to form the set of sequences to represent the different combinations of HARQ feedbacks.

In one exemplary embodiment, with the N selected sequences, the set of sequences to represent the different combinations of HARQ feedbacks may be generated as follows:

Cₖ[p]=Σ_{1≦I≦N}exp^{j2πik/K}Oᵢ[p], equation (2)

where
“Σ” denotes a summation;
i is a sequence index for the N selected sequences;
“exp” denotes the exponential function;
“j” denotes the imaginary unit;
π is the circular constant;
k is a sequence index for the generated set of sequences;
K is a total number of the generated set of sequences;
Oᵢ[p] is a mapped symbol of Sᵢ[p], e.g., Oᵢ[p]=2*Sᵢ[p]-1, wherein Sᵢ is an i^{th} one of the N selected sequences, and Sᵢ[p] is a p^{th} symbol of the i^{th} one of the N selected sequences;
Cₖ is a k^{th} one of the generated set of sequences; and
Cₖ[p] is the p^{th} symbol of the k^{th} one of the generated set of sequences.

For example, for the k^{th} one of the generated set of sequences, the exponential function has a group of values exp^{j2πik/K} (i=1, 2, . . . , N). The N selected sequences Sᵢ (i=1, 2, . . . , N) are first multiplied with the group of values exp^{j2πik/K} (i=1, 2, . . . , N), respectively, and are then summated to generate a composite sequence Cₖ, to represent the k^{th} one of the different combinations of HARQ feedbacks.

Referring to FIGS. 7A and 7B, in the illustrated embodiment, it is determined that first and second HARQ channels are established between a transmitter and a receiver, and the receiver concurrently transmits to the transmitter first and second HARQ feedbacks for the first and second HARQ channels, respectively. For each of the first and second HARQ channels, the receiver may transmit first, second, or third types of HARQ feedbacks, e.g., an ACK feedback, a NACK feedback, or a DROP feedback. Therefore, it is further determined that, for the first and second HARQ channels, there are first, second, . . . , and ninth combinations c₁, c₂, . . . , c₉ of HARQ feedbacks (702), as further explained below.

FIG. 7C is a table 720 showing the combinations c₁, c₂, . . . , c₉ of HARQ feedbacks, according to an exemplary embodiment. For example, the first combination c₁ may represent that the receiver provides an ACK feedback on the first HARQ channel and also provides an ACK feedback on the second HARQ channel. Also for example, the second combination c₂ may represent that the receiver provides an ACK feedback on the first HARQ channel and provides a NACK feedback on the second HARQ channel. Further for example, the ninth combination c₉ may represent that the receiver provides a DROP feedback on the first HARQ channel and also provides a DROP feedback on the second HARQ channel.

Referring to FIGS. 7A-7C, a subset of the predetermined sequence set 710 is then selected from the predetermined sequence set 710 (704). For example, a subset including the sequences S₁, S₂, S₃, and S₄ are selected from the predetermined sequence set 710. Accordingly, a set of sequences to represent the different combinations of HARQ feedbacks may be generated based on equation (2), as follows:

Cₖ[p]=Σ_{1≦i≦4}exp^{j2πik/9}Oᵢ[p], equation (3)

where k=1, 2, . . . , and 9, and the generated set of sequences c₁, c₂, . . . , c₉ represent the combinations c₁, c₂, c₉, respectively, as shown in FIG. 7C.

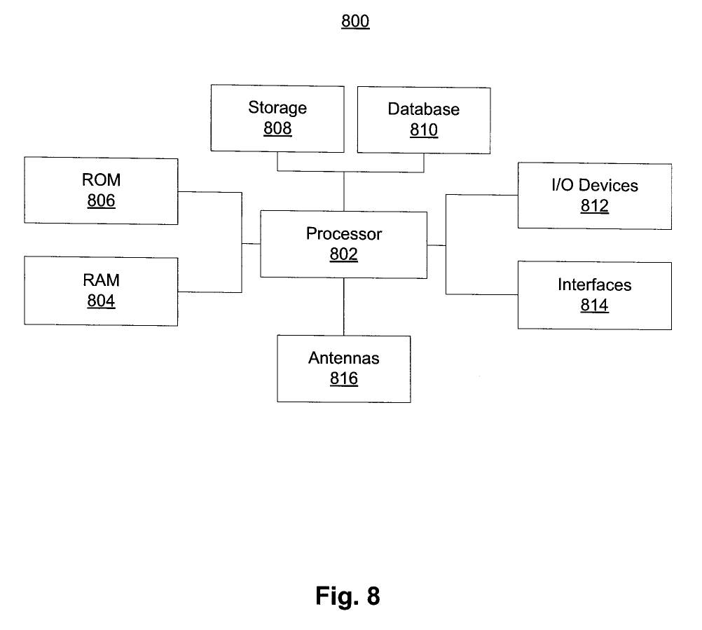

FIG. 8 illustrates a block diagram of a transmitter 800, according to an exemplary embodiment. For example, the transmitter 800 may be the transmitter 102 (FIG. 1). Referring to FIG. 8, the transmitter 800 may include one or more of the following components: a processor 802 configured to execute computer program instructions to perform various processes and methods, random access memory (RAM) 804 and read only memory (ROM) 806 configured to access and store information and computer program instructions, storage 808 to store data and information, databases 810 to store tables, lists, or other data structures, I/O devices 812, interfaces 814, antennas 816, etc. Each of these components is well-known in the art and will not be discussed further.

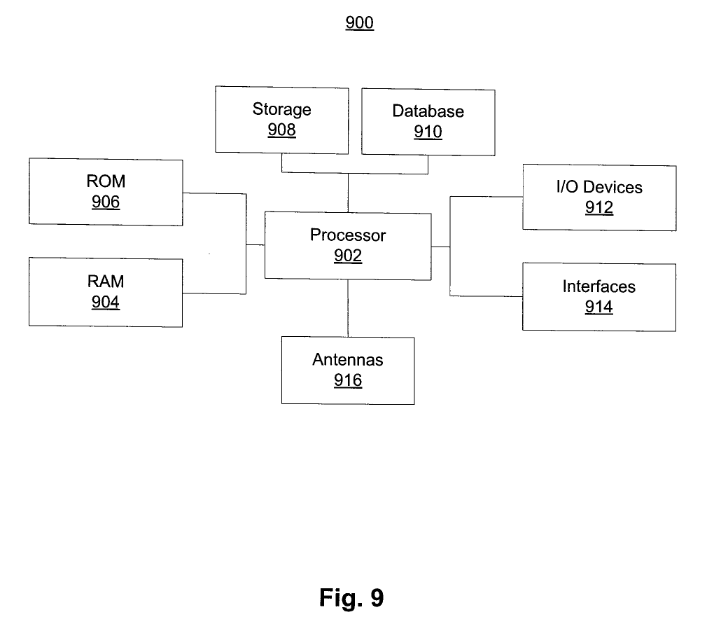

FIG. 9 illustrates a block diagram of a receiver 900, according to an exemplary embodiment. For example, the receiver 900 may be the receiver 104 (FIG. 1). Referring to FIG. 9, the receiver 900 may include one or more of the following components: a processor 902 configured to execute computer program instructions to perform various processes and methods, random access memory (RAM) 904 and read only memory (ROM) 906 configured to access and store information and computer program instructions, storage 908 to store data and information, databases 910 to store tables, lists, or other data structures, I/O devices 912, interfaces 914, antennas 916, etc. Each of these components is well-known in the art and will not be discussed further.

While embodiments have been described based on ACK, NACK, or DROP feedbacks, the invention is not so limited. It may be practiced with equal effectiveness with any other types of feedbacks or a plurality of signals that are to be concurrently transmitted from a receiver to a transmitter.

While embodiments have been described based on the HARQ scheme, the invention is not so limited. It may be practiced with equal effectiveness with other data retransmission schemes.

Other embodiments of the invention will be apparent to those skilled in the art from consideration of the specification and practice of the invention disclosed herein. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a receiver to provide a plurality of feedbacks to a transmitter, the plurality of feedbacks for use by the transmitter to determine data retransmission, the method comprising:
mapping the plurality of feedbacks to a sequence of symbols; and
transmitting the sequence of symbols to the transmitter.

2. The method of claim 1, wherein the receiver requests data retransmission from the transmitter based on a hybrid automatic repeat request (HARQ) scheme, the method comprising:
receiving, from the transmitter, data on a plurality of HARQ channels; and
determining the plurality of feedbacks for the data received on the plurality of HARQ channels, respectively.

3. The method of claim 1, wherein the receiver and the transmitter communicate based on a plurality of carriers, the method comprising:
receiving, from the transmitter, data on the plurality of carriers; and
determining the plurality of feedbacks for the data received on the plurality of carriers, respectively.

4. The method of claim 1, wherein the receiver and the transmitter communicate based on a multiple-input and multiple-output (MIMO) technique, the method comprising:
receiving, from the transmitter, data in a plurality of data streams; and
determining the plurality of feedbacks for the received data in the plurality of data streams, respectively.

5. A receiver to provide a plurality of feedbacks to a transmitter, the plurality of feedbacks for use by the transmitter to determine data retransmission, the receiver comprising:
a processor, the processor being configured to
map the plurality of feedbacks to a sequence of symbols; and
transmit the sequence of symbols to the transmitter.

6. The receiver of claim 5, being configured to request data retransmission from the transmitter based on a hybrid automatic repeat request (HARQ) scheme, wherein the processor is further configured to:
receive, from the transmitter, data on a plurality of HARQ channels; and
determine the plurality of feedbacks for the data received on the plurality of HARQ channels, respectively.

7. The receiver of claim 5, further comprising a plurality of carriers, wherein the processor is further configured to:
receive, from the transmitter, data on the plurality of carriers; and
determine the plurality of feedbacks for the data received on the plurality of carriers, respectively.

8. The receiver of claim 5, being configured to communicate with the transmitter based on a multiple-input and multiple-output (MIMO) technique, wherein the processor is further configured to:
receive, from the transmitter, data in a plurality of data streams; and
determine the plurality of feedbacks for the received data in the plurality of data streams, respectively.

9. The receiver of claim 5, being configured to communicate with the transmitter based on a time division duplex (TDD) technique.

10. The receiver of claim 5, further comprising:
a memory device for storing a plurality of sequences of symbols,
wherein the processor is configured to map the plurality of feedbacks to one of the plurality of sequences of symbols as the transmitted sequence of symbols.

11. A method for a transmitter to receive a plurality of feedbacks from a receiver, the plurality of feedbacks for use by the transmitter to determine data retransmission, the method comprising:
receiving a sequence of symbols from the receiver; and
mapping the sequence of symbols to the plurality of feedbacks.

12. The method of claim 11, wherein the transmitter transmits data to the receiver based on a hybrid automatic repeat request (HARQ) scheme, the method further comprising:
determining data retransmission on a plurality of HARQ channels based on the plurality of feedbacks, respectively.

13. A transmitter to receive a plurality of feedbacks from a receiver, the plurality of feedbacks for use by the transmitter to determine data retransmission, the transmitter comprising:
a processor, the processor being configured to
receive a sequence of symbols from the receiver; and
map the received sequence of symbols to the plurality of feedbacks.

14. The transmitter of claim 13, being configured to transmit data to the receiver based on a hybrid automatic repeat request (HARQ) scheme, wherein the processor is further configured to:
determine data retransmission on a plurality of HARQ channels based on the plurality of feedbacks, respectively.

15. The transmitter of claim 13, being configured to communicate with the receiver based on a time division duplex (TDD) technique.

16. The transmitter of claim 13, further comprising:
a memory device for storing different combinations of feedbacks,
wherein the processor is configured to map the received sequence of symbols to one of the different combinations of feedbacks as the plurality of feedbacks.

17. A computer-readable medium including instructions, executable by a processor of a computer, for performing a method for generating a plurality of sequences of symbols to represent different combinations of feedbacks provided by a receiver to a transmitter, the method comprising:
determining the different combinations of feedbacks, based on a number of channels for data transmission and a number of types of feedbacks for each of the channels; and
generating, based on a predetermined set of sequences of symbols, a plurality of sequences of symbols to represent the determined combinations of feedbacks, respectively.

18. The method of claim 17, wherein the generating comprises:
selecting sequences of symbols from the predetermined set of sequences of symbols to be the plurality of sequences of symbols.

19. The method of claim 17, wherein the generating comprises:
selecting sequences of symbols from the predetermined set of sequences of symbols; and
performing linear combinations on the selected sequences of symbols to generate the plurality of sequences of symbols.

20. The method of claim 19, wherein the linear combinations are performed based on constants or an exponential function.
